(19) United States
(12) Patent Application Publication
(10) Pub. No.: US 2009/0020137 A1
(43) Pub. Date: Jan. 22, 2009

(54) CLEANING APPARATUS AND METHOD, EXPOSURE APPARATUS HAVING THE CLEANING APPARATUS, AND DEVICE MANUFACTURING METHOD

(75) Inventor: Hiroshi Osawa, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/950,889

(22) Filed: Dec. 5, 2007

(30) Foreign Application Priority Data
Dec. 7, 2006 (JP) 2006-331128

(51) Int. Cl. B08B 6/00; B08B 1/00

(52) U.S. Cl. 134/1.3; 134/57 R

(57) ABSTRACT

A cleaning apparatus includes an irradiation unit configured to irradiate onto a substrate a laser beam having a pulse width of a picosecond-level or femtosecond-level range, and to clean the substrate via the laser beam.

### BACKGROUND OF THE INVENTION

The present invention relates to a cleaning apparatus, a cleaning method, an exposure apparatus having the cleaning apparatus, and a device manufacturing method. More particularly, the present invention relates to a cleaning apparatus that uses a pulsed laser to clean an optical element. The present invention is suitable, for example, for a cleaning apparatus that cleans an original in an exposure apparatus that uses as the extreme ultraviolet (“EUV”) light for exposure light.

A conventional projection exposure apparatus exposes a pattern of an original, such as a mask or reticle, (simply referred to as a “mask” hereinafter) a substrate, such as a wafer, via a projection optical system, and a high resolution exposure apparatus has been increasingly requested. One measure that meets the request is use of the exposure light having a shorter wavelength, and the EUV exposure apparatus has recently been proposed, which uses the EUV light having a wavelength between about 10 nm and about 20 nm smaller than that of the UV light.

In general, the EUV exposure apparatus uses a catoptric optical system that has no refractive member because of a high absorptance into a material of the light in the EUV light's wavelength range. In addition, a conventional pellicle for a dioptric optical system does not well transmit the EUV light. Thus, the mask cannot be equipped with the pellicle, and the mask patterned surface lies open. The “pellicle,” as used herein, is a high-transmittance thin film used to prevent an adhesion of a fine particle to a patterned surface. The fine particle is derived from a driving part that drives a mask, and a residue gas. The fine particle that has adhered to the mask patterned surface causes a poor transfer or a defect, and thus should be removed from the mask patterned surface.

Accordingly, a method for removing a fine particle is proposed by irradiating a pulsed laser beam. See, for example, Japanese Patent Laid-Open Nos. (“JPs”) 1-12526, 2-86128, and 10-64862, and G. Vereecke, E. Rohr, and M. M. Heyns, “Laser-assisted removal of particles on silicon wafers,” Journal of Applied Physics, Vol. 85, No. 7, 3837-3843, and Osamu Kato, Takahiko Mitsuda, Shinichi Ishizaka, “Cleaning of Silicon Wafer Surface Using Excimer Laser,” 48^{th} Laser Thermal Processing Association Papers, pp. 79-83, 1999.

Other prior art is Katsumi Midoricawa, “Femtosecond Laser Processing,” O plus E, pp. 1130-1136, 1999.

For example, when the pulsed laser is a KrF excimer laser, such a high optical energy as 200 mJ/cm²/pulse is necessary to remove a poly Styrene latex (“PSL”) particle with a 0.3 μm (300 nm). It is impractical to use such a high optical energy that is very close to the illuminance of 300 to 400 mJ/cm²/pulse, which is said to start be an optically damaging starting point for a silicon wafer surface. Moreover, the conventional cleaning method is not designed for a EUV mask that has a multilayer film on its surface. Thus, the conventional cleaning method causes problems of mask damages and poor cleaning.

### BRIEF SUMMARY OF THE INVENTION

The present invention is directed to a cleaning apparatus and method for effectively cleansing a substrate, an exposure apparatus having the cleaning apparatus, and a device manufacturing method.

A cleaning apparatus according to one aspect of the present invention includes an irradiation unit configured to irradiate onto a substrate a laser beam having a pulse width of a picosecond-level or femtosecond-level range, and to clean the substrate.

An exposure apparatus according to another aspect of the present invention configured to expose an exposed object using light having a wavelength of 20 nm or smaller includes a projection optical system configured to project a pattern of an original onto the exposed object, and the above cleaning apparatus configured to clean the original as a substrate. A device manufacturing method according to still another aspect of the present invention includes exposing an exposed object using the above exposure apparatus, and developing an exposed object that has been exposed.

A cleaning method according to another aspect of the present invention for cleansing a substrate by irradiating onto a substrate a laser beam having a pulse width of a picosecond-level or femtosecond-level range includes the step of setting the number of pulses of the laser beam irradiated onto the substrate such that an irradiation time can be equal to and greater than and closest to a release time necessary for a particle adhered to the substrate to release from the substrate.

A further object and other characteristics of the present invention will be made clear by the preferred embodiments described below referring to accompanying drawings.

### BRIEF DESCRIPTION OF THE DRAWINGS

FIG. 1 is a schematic block diagram of an exposure apparatus according to a first embodiment of the present invention.

FIG. 2 is a schematic block diagram of an irradiation unit in a cleaning apparatus shown in FIG. 1.

FIG. 3A is a graph that compares an emission pulse shape of a cleaning picosecond laser of this embodiment with that of another pulsed laser. FIG. 3B is a graph that compares an emission pulse shape of a conventional cleaning light source with that of this embodiment.

FIG. 4 is a flowchart for explaining a control method (cleaning method) for a controller shown in FIG. 2.

FIG. 5 is a schematic block diagram of another irradiation unit applicable to the cleaning apparatus shown in FIG. 1.

FIG. 6 is a partially enlarged sectional view for explaining a cooling mechanism for a mask shown in FIG. 1.

FIG. 7 is a schematic block diagram of a variation of an exposure apparatus shown in FIG. 1.

FIG. 8 is a flowchart for explaining a device manufacturing method shown in FIG. 1.

FIG. 9 is a detailed flowchart of the step 4 shown in FIG. 8.

### DESCRIPTION OF THE EMBODIMENTS

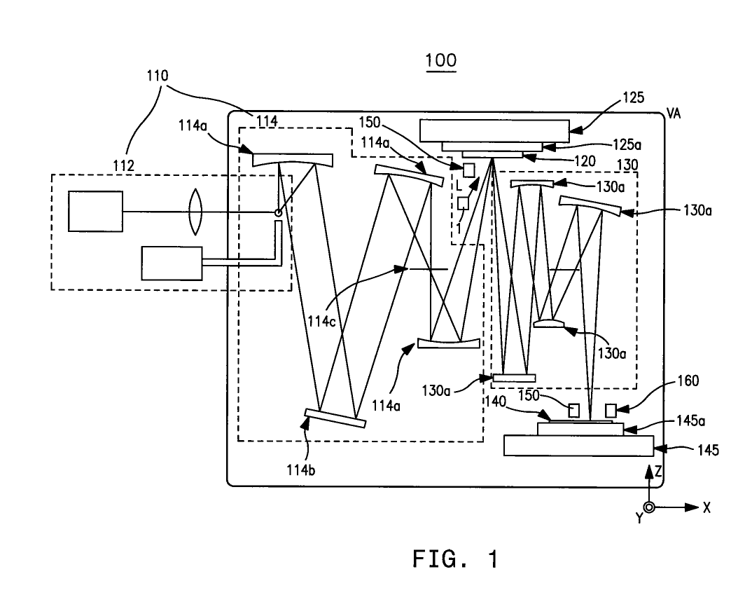

Referring now to FIG. 1, a description will be given of a cleaning apparatus 1 and a EUV exposure apparatus 100 having the same. Here, FIG. 1 is a schematic block diagram of the exposure apparatus 100.

The exposure apparatus 100 is a projection exposure apparatus that exposes a circuit patter of a mask 120 onto an exposed object (substrate) 140 in a step-and-scan manner using the EUV light (with a wavelength, for example, of 13.4 nm) for the exposure illumination light. The exposure apparatus 100 includes a cleaning apparatus 1, an illumination apparatus 110, a mask stage 125, a projection optical system 130, an alignment detection mechanism 150, and a focus position detection mechanism 160. Since the EUV light is hard to transmit through the air and causes contaminations as a result of reactions with the residue gas (polymer organic gas), an optical path (or the entire optical system) for the EUV light is maintained to be a vacuum atmosphere VA.

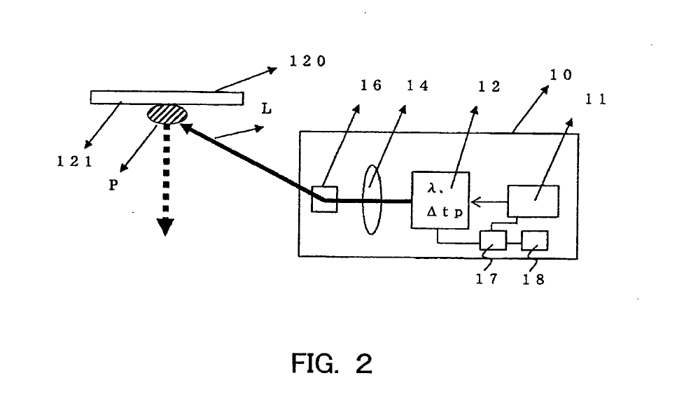

The cleaning apparatus 1 cleans the mask 120 in the EUV exposure apparatus 100. Here, FIG. 2 is a schematic block diagram of an irradiation unit 10 in the cleaning apparatus 1.

The irradiation unit 10 removes a fine particle P that has adhered to a mask patterned surface 121 by irradiating laser beam L onto the mask (original or substrate) 120. The irradiation unit 10 includes a pulse adjuster 11, a light source 12, a condenser lens 14, a scanning optical system 16, a controller 17, and a memory 18.

The cleaning apparatus 1 can apply various irradiation methods. A first irradiation method is a method for irradiating the laser beam onto part of the mask patterned surface 121 and for scanning the laser beam throughout the mask patterned surface. FIG. 1 adopts this method. A second irradiation method may simultaneously irradiate the laser beam onto the entire mask patterned surface 121, dispensing with the scanning optical system 16. A third irradiation method detects a position of the fine particle P on the mask patterned surface 121, and locally irradiates the laser beam only onto this position. The third irradiation method also dispenses the scanning optical system 16, but requires a detector that detects a position of the fine particle P.

The pulse adjuster 11 adjusts a pulse width (or duration) of the light source 12 to a pulse width set by the controller 17. Typically, the pulse adjuster 11 has plural selectable pulse widths. The controller 17 controls a selection of the pulse width by the pulse adjuster 11. In addition, the pulse adjuster 11 can adjust the laser's illuminance to the illuminance set by the controller 17.

The light source 12 is a pulsed laser light source. The laser beam is a femtosecond laser or a picosecond laser, such as a titan sapphire laser. A femtosecond or picosecond laser beam is preferable because it is less likely to damage the mask 120. The laser beam of this embodiment has an illuminance of 300 mJ/cm²/pulse or lower. “300 mJ” is set to prevent deformations and damages of the mask 120. Since about 300 mJ/cm² per pulse is a laser beam's illuminance that starts melting a material, such as Si and Mo, of a multilayer film in the EUV mask, this embodiment sets the laser beam's illuminance to 300 mJ/cm²/pulse or lower. The laser's illuminance can be set in accordance with the pulse width. In other words, the controller 17 sets the pulse width and illuminance, and the adjuster 11 adjusts the laser so as to provide the set pulse width and illuminance.

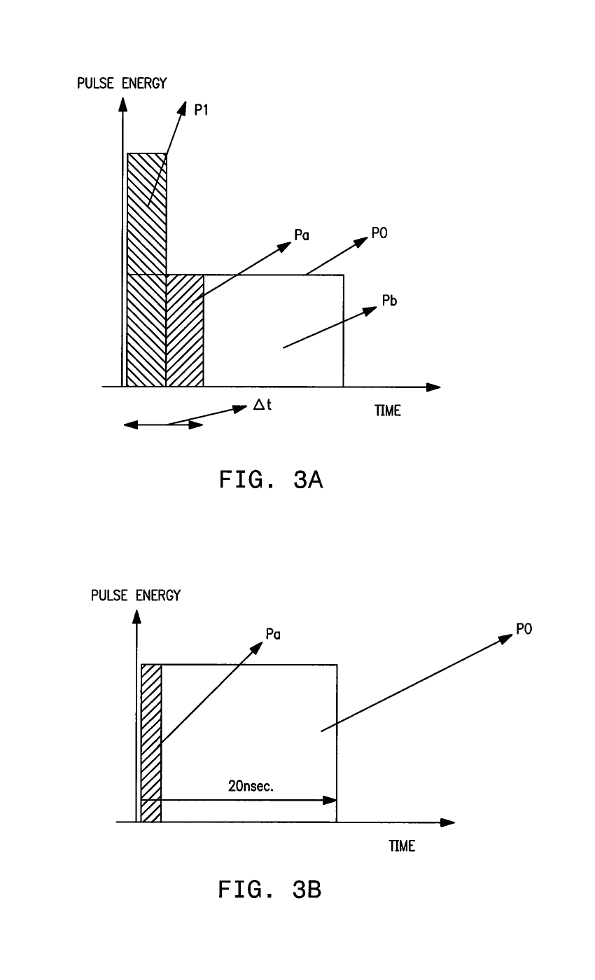

Referring now to FIGS. 3A and 3B, a description will be given of the pulse width of the light source 12. FIG. 3A is a graph that compares an emission pulse shape Pa of the cleansing picosecond laser of this embodiment with an emission pulse shape P0 of a KrF excimer laser and an emission pulse shape P1 of a femtosecond laser. Pb is a difference between the KrF excimer laser's emission pulse shape P0 and the picosecond laser's emission pulse shape Pa. FIG. 3B is a graph that compares the KrF excimer laser's emission pulse shape P0 for a conventional cleaning light source with the picosecond laser's emission pulse shape Pa.

The emission duration of the emission pulse shape P1 of the femtosecond laser is generally about 10 to 1000 femtoseconds (1×10⁻¹⁵ seconds). The emission duration of the emission pulse shape Pa of the picosecond laser is generally about 1 to 500 picoseconds (picosecond: 1×10⁻¹² seconds). The emission duration of the emission pulse shape P0 of the KrF excimer laser is generally about 7 to 25 nanoseconds (nanosecond: 1×10⁻⁹ seconds).

Δt in FIG. 3A denotes a time period (release time) necessary for a fine particle that has adhered to the mask surface 121 to release as soon as the laser beam enters the EUV mask surface. Usually, this time period is about 1 to 100 picoseconds. Katumi Midorikawa's “femtosecond laser processing” explains a mechanism from an incidence of the laser upon the substrate surface to a generation of a lattice vibration of the substrate. The “femtosecond laser processing” states as follows: 1) Free electrons generated by the light absorptions reach a thermal equilibrium state in such a short time period as 100 femtoseconds or smaller due to collisions. 2) The energy stored in this electron system is emitted as a phonon in a picosecond order, and induces the lattice vibrations in the solid. 3) The energy of the lattice vibration diffuses as heat in the solid, which appears as a temperature rise.

In other words, it is a picosecond order from when the laser enters the substrate surface to when the instant thermal expansion occurs in the substrate. For the KrF excimer laser, the instant thermal expansion of the substrate starts before the laser's emission ends. The optical cleaning is a release of a fine particle associated with an instant thermal expansion of the substrate, and thus the KrF excimer laser's emission duration is shorter than the release time of the fine particle.

More specifically, in the irradiation of the KrF excimer laser, an incidence upon the mask 120 of the light that does not contribute to the optical cleaning continues by the time period Pb even after the time period Δt shown in FIG. 3A, and the thermal damage of the mask 120 progresses during the time period Pb.

On the other hand, in optical cleansing with the picosecond laser, its pulse emission duration Pa is approximately as long as the time period Δt, and thus the time period that does not contribute to optical cleansing is much shorter than the time period Pb. It is thus understood that the laser's cleaning efficiency is high and the optical damage time is short. The femtosecond laser also provides a similar effect because its pulse width is shorter than that of the picosecond laser with almost no time that does not contribute to optical cleaning, thus reducing optical damages of the mask 120.

A cleaning effect of this embodiment was confirmed as follows: Initially, 50-nm fluorescent PSL particles were scattered at a density of about 100 pieces/cm² on a Si wafer. Then, a femtosecond laser with an emission duration of 100 femtoseconds was irradiated with 100 pulses after the laser beam was condensed by a lens down to the illuminance of 30 mJ/cm²/pulses. The removal ratio of the fluorescent PSL particles was measured with Olimpus fluorescent microscope that can well observe 50-nm fluorescent particles. The fluorescent PSL particles that had been scattered could be removed almost completely. As a result of that the Si wafer surface was observed with a dark field illumination using an objective lens with 100 times, no optical damages were found. Spectra-Physics Spitfire® was used for the femtosecond laser, which has a wavelength of 266 nm, a repetitive frequency of 1 kHz, a pulse width of 100 femtoseconds, a pulsed energy of 200 μJ, and a Gaussian beam shape.

Spectra-Physics Spitfire® can change a pulse width among 40 to 500 femtoseconds, 2 picoseconds, and 200 picoseconds by adjusting an optical system in the laser. Another femtosecond or picoseconds laser would also provide a similar effect when used for a laser light source that has different emission durations in a range from about 1 femtosecond to 1 nanosecond.

Assume that P (Watt/mm²) is a power per a certain unit area and is an energy per a unit time and a unit area of a light source, and t (seconds) is an emission duration. Then, energy Q per a unit area projected to the mask surface becomes Q=Pt. Assume Qc=Pct is the energy per a unit area that starts damaging the mask due to the light projected onto the mask surface. For a prevention of mask's optical damages, the power P per a unit area that is the energy per a unit time and unit area of the light source is preferably smaller than the power Pc that starts damaging the mask.

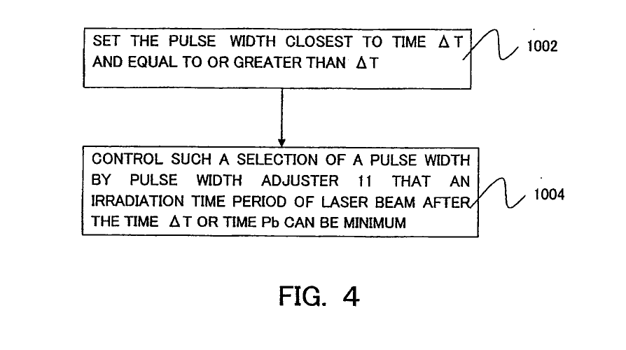

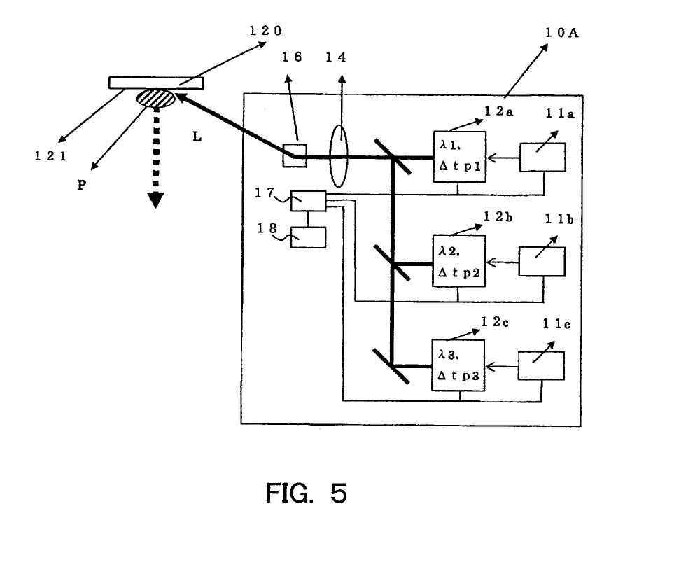

Turning back to FIG. 2, the condenser lens 14 condenses or spreads the laser beam. The scanning optical system 16 includes a galvano mirror etc., and scans on the entire mask 120 surface the laser beam that is partially irradiated onto the mask 120. The controller 17 sets the number of pulses and the pulse width of the laser beam. The memory 18 stores the time period Δt, the information on the laser beam's pulse width, and a control method (or cleaning method) executed by the controller 17 shown in FIG. 4, and other necessary information. This is true of FIG. 5, which will be described later.

Referring now to FIG. 4, the controller 17 sets the pulse width that is a time period Δt or greater and closest to the time period Δt and the number of pulses that corresponds to a time period Δt′ or greater and closest to the time period Δt′ (step 1002). The number of pulses is a natural number. The time period Δt′ is a time period necessary for radiations of plural pulses to finish removals of plural particles or almost all particles that adhere to the substrate. When there are plural particles that adhere to the EUV mask surface and have different sizes and absorptive powers to the substrate, irradiations of plural pulses can enhance the particle release with no optical damages, which is a characteristic of the present invention. Thereby, the irradiation time of the laser beam after time period Δt or Δt′, that is the optical damage time, becomes short. In addition, the controller 17 controls a selection of the pulse width by the pulse adjuster 11 such that the irradiation time of the laser beam after time period Δt or the optical damage time becomes minimum (step 1004). Thereby, the optical damage time becomes shorter. Moreover, as shown in FIG. 3, the controller 17 may set the laser's illuminance in accordance with the pulse width set by the step 1002.

The cleaning apparatus 1 may use the irradiation unit 10A shown in FIG. 5. Here, FIG. 5 is a schematic block diagram of the irradiation unit 10A. Laser beams emitted from light sources 12a, 12b, and 12c are different from one another with respect to one or more or a wavelength, a pulse width, and an illuminance. Similarly, they are different from one another with respect to one or more of the pulse adjusters 11a, 11b, and 11c of the light sources.

The light sources 12a, 12b, and 12c that generate plural different types of laser beams are suitable for removals of fine particles P having plural different types and sizes. The plural types of fine particles P, such as a metallic particle and a metalloid particle, can be cleaned by laser beams having different wavelengths and/or different pulse width, and the fine particles P having different sizes can be cleaned by different laser beams having different illuminances. Of course, they are combinable, and thus two or more light sources may be enough. The controller 17 controls each of the adjusters 11a, 11b, and 11c so that the respective light sources 12a, 12b, and 12c have set wavelengths, pulse widths, and illuminaces. The mask (substrate) 120 is illuminated by the adjusted lasers.

Turning back to FIG. 1, the illumination apparatus 110 illuminates the mask 120 using the arc-shaped EUV light corresponding to the arc shape of the projection optical system 130, and includes a EUV light source section 112, and an illumination optical system 114.

The EUV light source section 112 uses a laser-induced plasma light source, but may use a discharge-induced plasma light source. The illumination optical system 114 includes a condenser mirror 114a, an optical integrator 114b, and an aperture (stop) 114c. The condenser mirror 114a collects the EUV light that is isotropically radiated from the laser plasma light source. The optical integrator 114b uniformly illuminates the mask 120 at a predetermined numerical aperture (“NA”). The aperture 114c is provided at a position conjugate with the mask 120, and limits the illumination area of the mask 120 to an arc shape.

The mask 120 is a reflection mask, and supported and driven by the mask stage 125. The diffracted light emitted from the mask 120 is reflected on the projection optical system 130, and projected onto the exposed object 140. The mask 120 and the exposed object 140 are arranged in an optically conjugate relationship. Since the exposure apparatus 100 is a step-and-scan exposure apparatus, a reduced pattern of the mask 120 is projected onto the exposed object when the mask 120 and the exposed object 140 are synchronously scanned.

The mask stage 125 is connected to a moving mechanism (not shown), and supports the mask 120 via a mask chuck 125a. The mask stage 125 can apply any structures known in the art. The mask chuck is an electrostatic chuck that absorbs the mask 120 through an electrostatic absorptive force.

The projection optical system 130 projects a reduced image of a mask pattern onto the exposed object 140 by using plural multilayer mirrors 130a. The number of mirrors 130a is about four to about 6. For a wide exposure area with the smaller number of mirrors, the mask 120 and the exposed object 140 are simultaneously scanned to transfer a wide area by using only a thin arc area (ring field) distant from the optical axis by a predetermined distance.

The mirror 130a has a multilayer film, such as Mo and Si, on a reflection surface that is made by cutting and polishing and shaping a substrate made of a material, such as low thermal expansion glass and SiC, which has a high rigidity, a high hardness, and a small coefficient of thermal expansion. The mirror 130a has a convex or concave spherical or aspheric reflection surface, and about 0.1 to about 0.2 NA.

The exposed object 140 is a wafer in this embodiment, but covers a liquid crystal substrate and another substrate. A photoresist is applied onto a surface of the exposed object 140.

The wafer stage 145 supports the exposed object 140 through a wafer chuck 145a. The wafer stage 145 moves the exposed object 140, for example, by using a linear motor. The wafer chuck 145a is a hyperbolic electrostatic chuck having two electrodes and structured on a rough-movement stage and a fine-movement stage.

The alignment detection mechanism 150 measures a positional relationship between the position of the mask 120 and the optical axis of the projection optical system 130, and a positional relationship between the position of the exposed object 140 and the optical axis of the projection optical system 130. The alignment detection mechanism 150 sets positions and angles of the mask stage 125 and the wafer stage 145 such that a projected image of the mask 120 accords with a predetermined position of the exposed object 140.

The focus position detection mechanism 160 measures a focus position in a so-called Z direction on the exposed object 140. The focus position detection mechanism 160 always maintains the surface of the exposed object 140 at an imaging position by the projection optical system 130 during exposure by controlling the position and angle of the wafer stage 145.

Prior to exposure, the cleaning apparatus 1 cleans the mask 120. The mask 120 is cleaned for each pulse. This embodiment sets an emission duration of the light irradiated from the cleaning apparatus 1 as long as the release time of the fine particle from the mask surface. Approximately as soon as the fine particle releases from the mask surface, the laser irradiation onto the EUV mask surface stops. Thus, fine particles can be removed well while the illuminance of the light irradiated onto the multilayer film on the mask surface is maintained low enough to prevent optical damages of the mask.

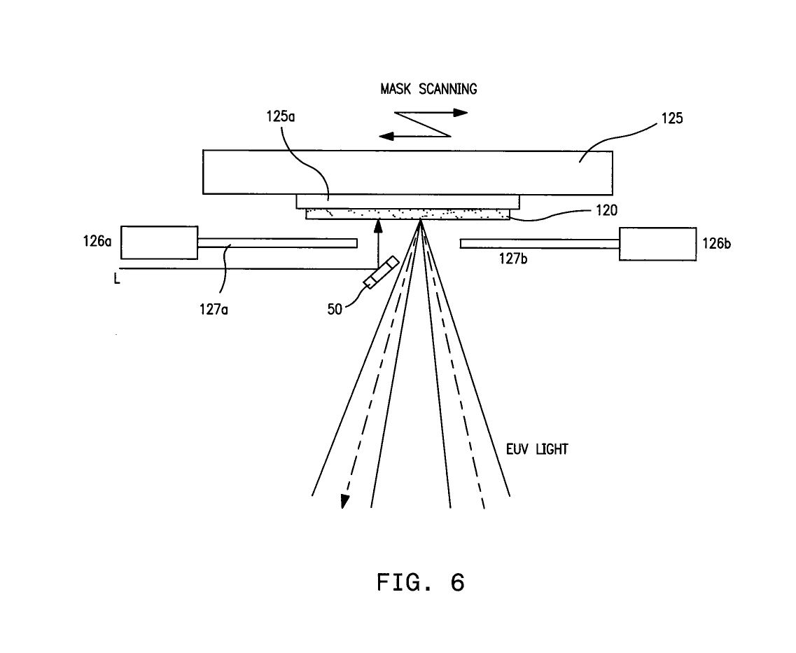

The mask 120 thermally expands due to cleansing, and should be cooled before exposure. For example, the entire mask 120 thermal expands by about 7.5 nm when its base is made of a ultra-low thermal expansion material, such as Zerodure® (with a coefficient of thermal expansion of 0.05 E-6/K) and the temperature rises by 1° C. due to the laser irradiation. FIG. 6 shows a block diagram of one example of the cooling means.

In FIG. 6, the laser beam L is irradiated onto the mask 120 via the mirror 50. The cooling means includes electron cooling means 126a and 126b, and cooling plates 127a and 127b connected to them. The electron cooling means 126a and 126b include Peltier elements. The cooling means uses radiation cooling with the cooling plates 127a and 127b. An effective material of each of the cooling plates 127a and 127b has a high thermal conductivity and an emissivity close to 1. Each of the cooling plates 127a and 127b has a dimension to cover the entire mask surface, and is arranged near the mask as shown in FIG. 6. Thereby, a form factor between the heat source and the cooling plate, which is important to the radiation cooling, can be made nearly 1, and the energy applied by the pulsed laser irradiation can be efficiently recovered. The cooling means is not limited to this embodiment, but may use any means, such as cooling by flowing a coolant through the cooling plate.

In exposure, the illumination apparatus 100 uniformly illuminates the mask 120 so as to project the mask pattern onto the exposed object 140 through the projection optical system 130. The cleaning apparatus 1 provides cleansing in the exposure apparatus 100, and the mask 120 is not exposed to the external atmosphere to the vacuum atmosphere VA. Therefore, the mask 120 is protected from a fine particle in the external atmosphere. In addition, the cleaning apparatus 1 can efficiently removes the fine particles from the mask stage 125 and the residue gas in the vacuum atmosphere VA, and thus provides a high-quality exposure.

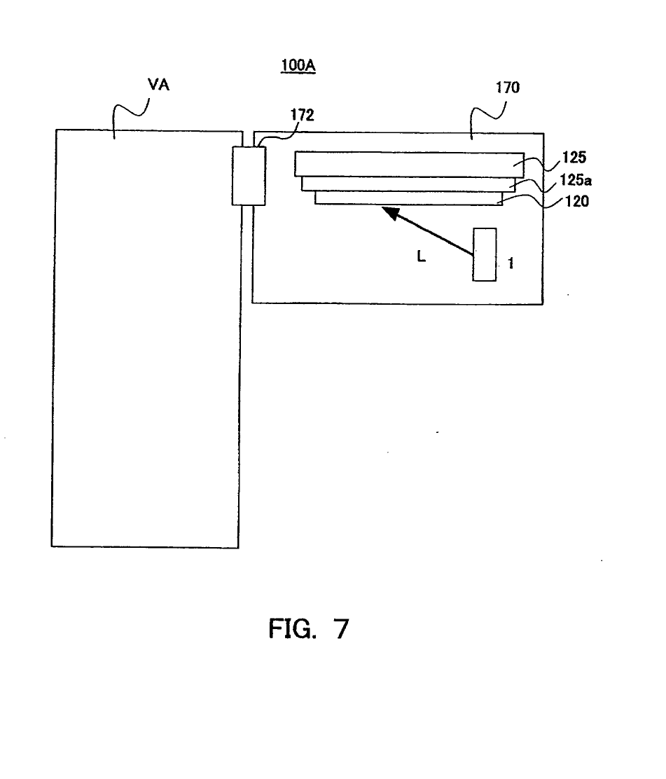

FIG. 7 shows a EUV exposure apparatus 100A as a variation of the EUV exposure apparatus 199. FIG. 7 provides the cleaning apparatus 1 to a vacuum chamber 170 that is connected to the vacuum atmosphere VA via a mask exchanging mechanism 172, such as a gate value. The EUV exposure apparatus 100A can cleans the mask 120 and remove fine particles before exposure, restraining the reduced yield. The EUV exposure apparatus 100A also provides the cleaning apparatus 1 in the exposure apparatus having a maintained vacuum atmosphere, and is not subject to the external atmosphere. The EUV exposure apparatus 100A is preferable when the EUV exposure apparatus has no spatial latitude to provide the cleaning apparatus 1 in the vacuum atmosphere VA unlike the exposure apparatus 100.

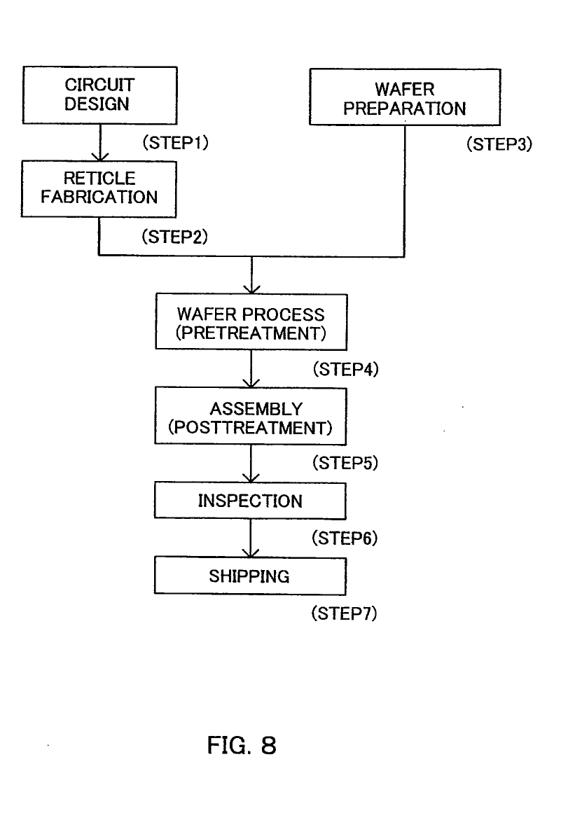

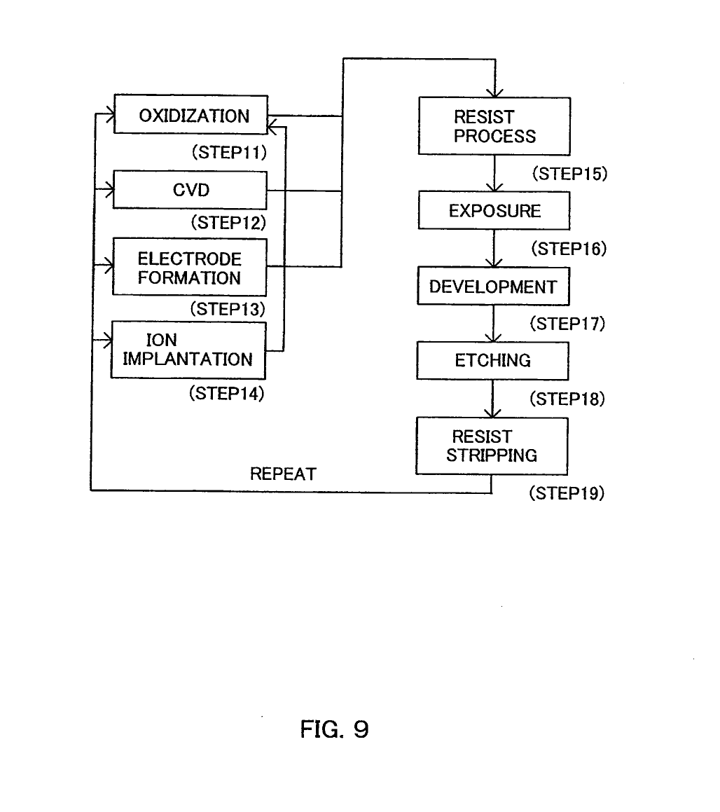

Referring now to FIGS. 8 and 9, a description will be given of an embodiment of a device manufacturing method using the exposure apparatus 100 or 100A. FIG. 8 is a flowchart for explaining manufacture of devices, such as a semiconductor chip (e.g., an IC and an LSI), a liquid crystal panel, and a CCD. Here, a description will be given of the fabrication of a semiconductor device as an example. Step 1 (circuit design) designs a semiconductor device circuit. Step 2 (mask fabrication) forms a mask having a designed circuit pattern. Step 3 (wafer preparation) manufactures a wafer using materials such as silicon. Step 4 (wafer process), which is also referred to as a pretreatment, forms the actual circuitry on the wafer through lithography using the mask and wafer. Step 5 (assembly), which is also referred to as a post-treatment, forms into a semiconductor chip the wafer formed in Step 4 and includes an assembly step (e.g., dicing, bonding), a packaging step (chip sealing), and the like. Step 6 (inspection) performs various tests on the semiconductor device made in Step 5, such as a validity test and a durability test. Through these steps, a semiconductor device is finished and shipped (Step 7).

FIG. 9 is a detailed flowchart of the wafer process in Step 8. Step 11 (oxidation) oxidizes the wafer's surface. Step 12 (CVD) forms an insulating layer on the wafer's surface. Step 13 (electrode formation) forms electrodes on the wafer by vapor disposition and the like. Step 14 (ion implantation) implants ions into the wafer. Step 15 (resist process) applies a photosensitive material onto the wafer. Step 16 (exposure) uses the exposure apparatus 100 or 100A to expose a mask pattern onto the wafer. Step 17 (development) develops the exposed wafer. Step 18 (etching) etches parts other than a developed resist image. Step 19 (resist stripping) removes unused resist after etching. These steps are repeated to form multi-layer circuit patterns on the wafer. The device manufacturing method of this embodiment may manufacture higher quality devices (such as a semiconductor device, an LCD device, an image pickup device (e.g., CCD), and a thin film magnetic head) than ever. Thus, the device manufacturing method using the exposure apparatus 100 or 10A, and a resultant device (intermediate and final products) also constitute one aspect of the present invention.

The cleaning apparatus 1 of this embodiment improves the throughput since it is unnecessary to clean the mask 120 outside the exposure apparatus 100. In addition, a fine particle can be removed without damaging the mask pattern during cleansing.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions. For example, a polarization direction of the light is not necessarily perpendicular to the pattern row if it is a direction of an effective removal of the fine particle. In addition, the cleaning apparatus 1 can be widely applied to cleansing of an optical element and a substrate, such as a nanoimprint original and an injection molding original as well as the mask for the exposure apparatus.

This application claims a foreign priority benefit based on Japanese Patent Application No. 2006-331128, filed on Dec. 7, 2006, which is hereby incorporated by reference herein in its entirety as if fully set forth herein.

What is claimed is:

1. A cleaning apparatus comprising an irradiation unit configured to irradiate onto a substrate a laser beam having a pulse width of a picosecond-level or femtosecond-level range, and to clean the substrate via the laser beam.

2. A cleaning apparatus according to claim 1, wherein the pulse width is 1 nanosecond or shorter.

3. A cleaning apparatus according to claim 1, further comprising:
a controller configured to set the pulse width of the laser beam irradiated onto the substrate from the irradiation unit based on a release time necessary for a particle that has adhered to the substrate to release from the substrate; and
an adjuster configured to adjust the pulse width of the laser beam to the pulse width that has been set.

4. A cleaning apparatus according to claim 3, wherein the controller sets the pulse width from among plural different pulse widths by selecting the pulse width that is equal to or greater than the release time and closest to the release time.

5. A cleaning apparatus according to claim 3, wherein the controller is configured to set an illuminance of the laser beam irradiated onto the substrate from the irradiation unit based on the release time, and the adjuster adjusts the illuminance of the laser beam to the illuminance that has been set.

6. A cleaning apparatus according to claim 1, wherein the laser beam has an illuminance of 300 mJ/cm²/pulse or smaller.

7. A cleaning apparatus according to claim 1, further comprising a controller configured to set the number of pulses width of the laser beam irradiated onto the substrate from the irradiation unit based on a time necessary for a plurality of particles that has adhered to the substrate to release from the substrate.

8. A cleaning apparatus according to claim 1, wherein the irradiation unit includes plural light sources configured to irradiate plural laser beams, the plural light sources being different from each other with respect to at least one of a wavelength, a pulse width, and an illuminance.

9. An exposure apparatus configured to expose an exposed object using light having a wavelength of 20 nm or smaller, said exposure apparatus comprising:
a projection optical system configured to project a pattern of an original onto the exposed object; and
a cleaning apparatus according to claim 1 configured to clean the original as a substrate.

10. A device manufacturing method comprising the steps of:
exposing an exposed object using an exposure apparatus and light having a wavelength of 20 nm or smaller; and
developing an exposed object that has been exposed,
wherein the exposure apparatus includes a projection optical system configured to project a pattern of an original onto the exposed object, and a cleaning apparatus according to claim 1 configured to clean the original as a substrate.

11. A cleaning method for cleansing a substrate by irradiating onto a substrate a laser beam having a pulse width of a picosecond-level or femtosecond-level range, said cleaning method comprising the step of setting the number of pulses of the laser beam irradiated onto the substrate such that an irradiation time can be equal to and greater than and closest to release time necessary for a particle that has adhered to the substrate to release from the substrate.

12. A cleaning method according to claim 9, further comprising the step of selecting the pulse width from among plural types of pulse widths so as to minimize the irradiation time of the laser beam after the release time.

13. A cleaning method for cleaning a substrate by irradiating onto the substrate a laser beam that have a pulse width of a picosecond-level or femtosecond-level range.

14. A cleaning method according to claim 11, further comprising the step of setting the pulse width of the laser beam irradiated onto the substrate from the irradiation unit based on a release time necessary for a particle that has adhered to the substrate to release from the substrate.

15. A cleaning method according to claim 12, wherein the setting step sets the pulse width from among plural different pulse widths by selecting the pulse width that is equal to or greater than the release time and closest to the release time.

16. A cleaning method according to claim 12, wherein further comprising the step of setting an illuminance of the laser beam irradiated onto the substrate from the irradiation unit based on the release time.

17. A cleaning method according to claim 11, further comprising the step of setting the number of pulses width of the laser beam irradiated onto the substrate from the irradiation unit based on a time necessary for a plurality of particles that has adhered to the substrate to release from the substrate.

18. A cleaning method according to claim 11, further comprising the step of irradiating onto the substrate plural laser beams being different from each other with respect to at least one of a wavelength, a pulse width, and an illuminance.
